(19) United States
(12) Patent Application Publication
(10) Pub. No.: US 2008/0252185 A1
(43) Pub. Date: Oct. 16, 2008

(54) File storage system for hanging files

(76) Inventor: Ramzan Mohammed, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 11/787,603

(22) Filed: Apr. 16, 2007

(51) Int. Cl. B42F 15/00

(52) U.S. Cl. 312/184

(57) ABSTRACT

A sliding file storage frame for mounting in a cabinet having a front opening door includes a rectilinear brace frame that is affixed to left and right drawer slides for longitudinal translation in and out of the cabinet. The drawer slides have a fixed section and at least one sliding section wherein the sliding section is affixed to the respective sides of the rectilinear brace frame. A hanging file support grid is supported intermediate to the front and rear braces and intermediate to the left and right sides of the rectilinear brace frame between the left and right drawer slides.

### BACKGROUND OF THE INVENTION

1. Field of the Invention

The present invention relates to file storage in general and more particularly to systems for storing hanging files that are mountable in cabinets.

2. Discussion of the Related Art

Businesses, government, and individuals have found over the years that detailed record keeping is a vital element of their daily existence. Whether the records are financial, legal, or just a compilation of daily activities, these records are a vital necessity. Computers and electronic media have become an increasing part of society's record keeping process by storing many records in electronic format rather than on the more traditional paper format. Although the use of electronic means to store records is becoming more widely accepted and utilized, there still remains a vast need and demand for the maintenance of paper records.

Traditionally, paper files have been kept in cabinets specially designed for this purpose. For a long time, file cabinets were constructed first of wood, then of steel in one basic design, that of 2-5 file drawers vertically arranged one above another in a single cabinet. The drawers were mounted on slides that permitted the file drawers to be partially extracted from the cabinet to permit an individual to access, insert, or remove files from the drawer. These cabinets were designed from a strictly utilitarian aspect and there was never any doubt about the function of the cabinet. Initially, files were merely placed in a drawer that was appropriately sized to accept standard letter size stationary or in larger drawers sized to accept legal size stationary and their respective file folders. Subsequently, metal frames were added to the drawers wherein the frames were constructed to accept hanging folders into which traditional file folders or papers could be placed. The benefit of the hanging folders being that adjacent folders were not necessary to hold other files in a vertical and easily accessible position.

Recent years have witnessed the desire of businesses and organizations to make the workplace more comfortable by fabricating office furnishings in new designs that are more aesthetic in appearance while maintaining a desired utilitarian function. Indeed, while large businesses may still opt for file storage in more traditional file cabinets where aesthetics are of little import, smaller organizations such as doctor's offices and even homes that have a definite need for file storage often wish to incorporate their file storage into areas that are not obviously meant for file storage. They have an increasing desire that the file storage units contribute to the aesthetics of the surrounding area.

While file storage unit designs have become increasingly more aesthetic in recent years, they primarily remain individual units that are supported on the floor and that can be readily recognized as file storage. Many organizations and homeowners may not have the available square footage needed for these units, and thus desire alternate means for storing their files. One possible alternate means of file storage is in furniture-like cabinets such as or similar to kitchen cabinetry that can be mounted to a wall and raised off the floor. However, these standard cabinets typically do not offer options that would permit the cabinets to be utilized for file storage.

Thus what is desired is a file storage system that can be mounted in standard cabinetry that permits convenient access to individual files.

### SUMMARY OF THE INVENTION

The present invention is directed to a sliding file support frame that satisfies the need for a file storage system that can be mounted in standard cabinetry having a front opening door. The sliding file support frame includes a rectilinear brace frame that is affixed to left and right drawer slides for longitudinal translation in and out of the cabinet. The drawer slides have a fixed section and at least one sliding section wherein the sliding section is affixed to the respective sides of the rectilinear brace frame. A hanging file support grid is supported intermediate to the front and rear braces and intermediate to the left and right sides of the rectilinear brace frame between the left and right drawer slides.

Another embodiment of the sliding file support frame utilizes the distal sliding sections of drawer slides as the ends of the rectilinear brace frame such that front and rear braces affix directly to the distal sliding sections of the left and right drawer slides. The hanging file support grid is supported intermediately within the bounds of the front and rear braces and the left and right distal sections of the drawer slides.

The hanging file support grid in the various embodiments include a plurality of spaced apart parallel rods to accept hanging files therebetween and are spaced such that the hanging files engage and are supported by the rods. The sliding file support frame can be of single file width or of a width for supporting multiple files in a side-by-side configuration.

These and other features, aspects, and advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a general perspective view of a floor supported kitchen type cabinet incorporating a sliding file storage frame embodying the present invention;

FIG. 2 is a top plan view of the sliding file storage frame in its retracted position in a cabinet and its extended position shown in phantom;

FIG. 3 is a top plan view of an alternate embodiment sliding file storage frame illustrating a side-by-side sliding file storage frame for use in a wide cabinet;

FIG. 4 is a partial cross-sectional elevation view of the sliding file storage frame shown in FIG. 2 and illustrating the mounting of the sliding frame between side walls of the cabinet taken along the line 3-3, FIG. 2;

FIG. 5 is an enlarged view of the slide mounting area of the sliding file storage frame shown in FIG. 4 and denoted by the circled area 5, FIG. 4;

FIG. 6 is a partial perspective view of the sliding file storage frame;

FIG. 7 is a partial perspective view of an alternate embodiment of the sliding file frame.

Like reference numerals refer to like parts throughout the several views of the drawings.

### DETAILED DESCRIPTION OF THE PREFERRED EMBODIMENTS

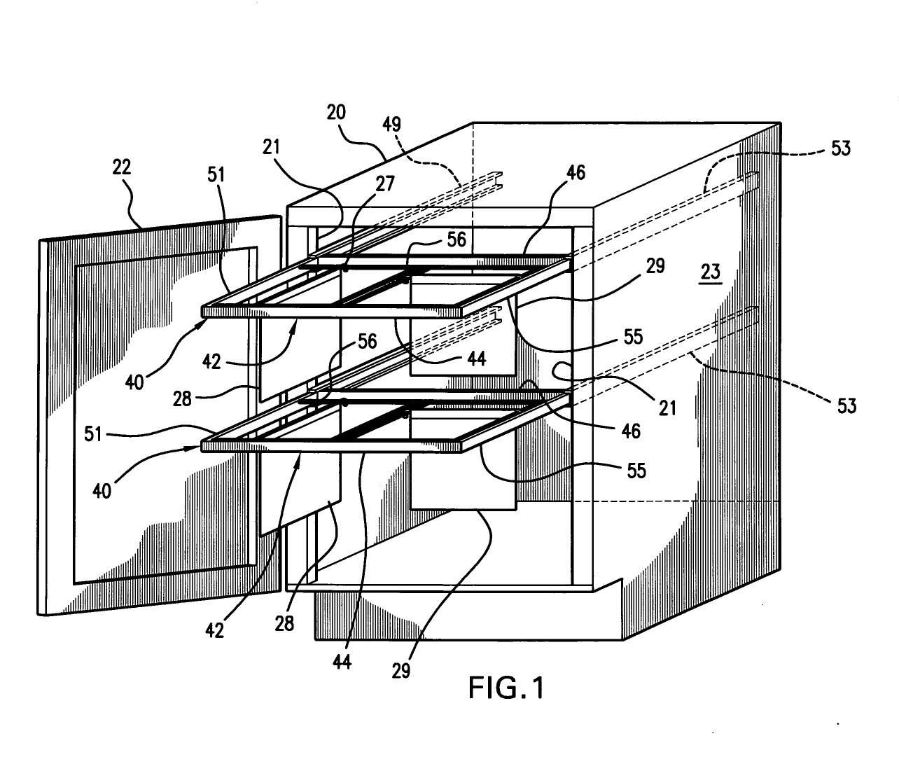

For purposes of description herein, the terms “upper”, “lower”, “left”, “rear”, “right”, “front”, “vertical”, “horizontal”, and derivatives thereof shall relate to the invention as oriented in FIG. 1 and further with the term “longitudinal” referring to a front to rear direction and the term “transverse” referring to a left to right direction. However, one will understand that the invention may assume various alternative orientations and step sequences, except where expressly specified to the contrary. While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

Turning to the drawings, FIG. 1 shows a floor supported kitchen-type cabinet 20 having a front opening door 22 in which are mounted two sliding file support frames 40 which are one of the preferred embodiments of the present invention and illustrates its various components. While cabinet 20 is shown as a floor supported unit, sliding file support frames 40 can also be installed in wall mounted cabinets in similar manner as discussed below.

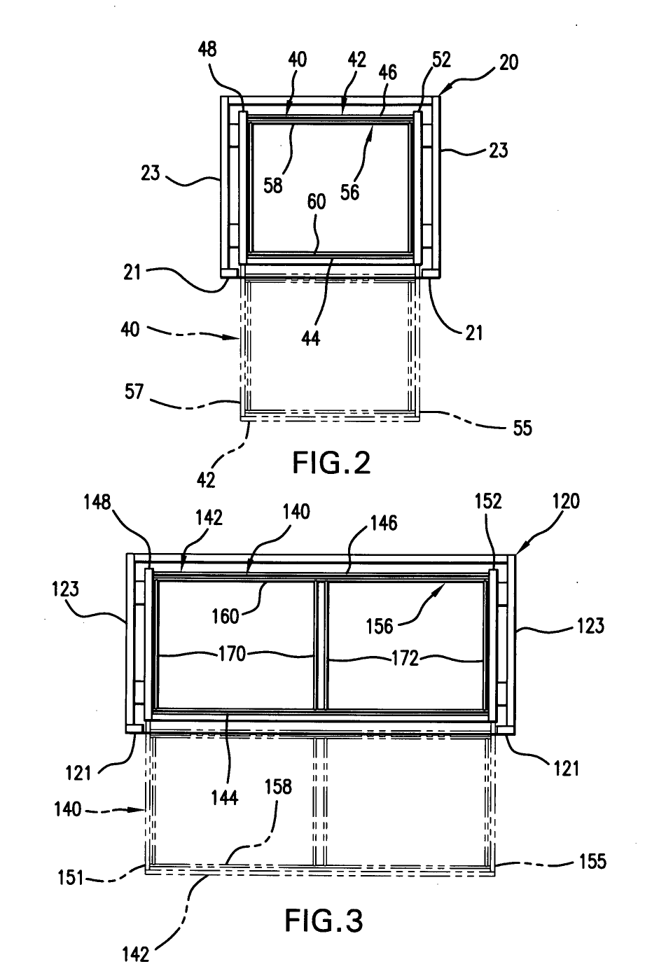

FIGS. 1-2 illustrate a first embodiment of the sliding file support frame 40 wherein a rectilinear brace frame 42 is affixed to a left drawer slide 48 and a right drawer slide 52 for mounting in cabinet 20 to permit rectilinear brace frame 42 for longitudinally translation from a stored position (shown in solid lines in FIG. 2) to an extended position (shown in phantom lines in FIG. 2). Rectilinear brace frame 42 includes a front brace 44 and a rear brace 46 that are longitudinally spaced one from the other and extend transversely between left and right drawer slides 48, 52.

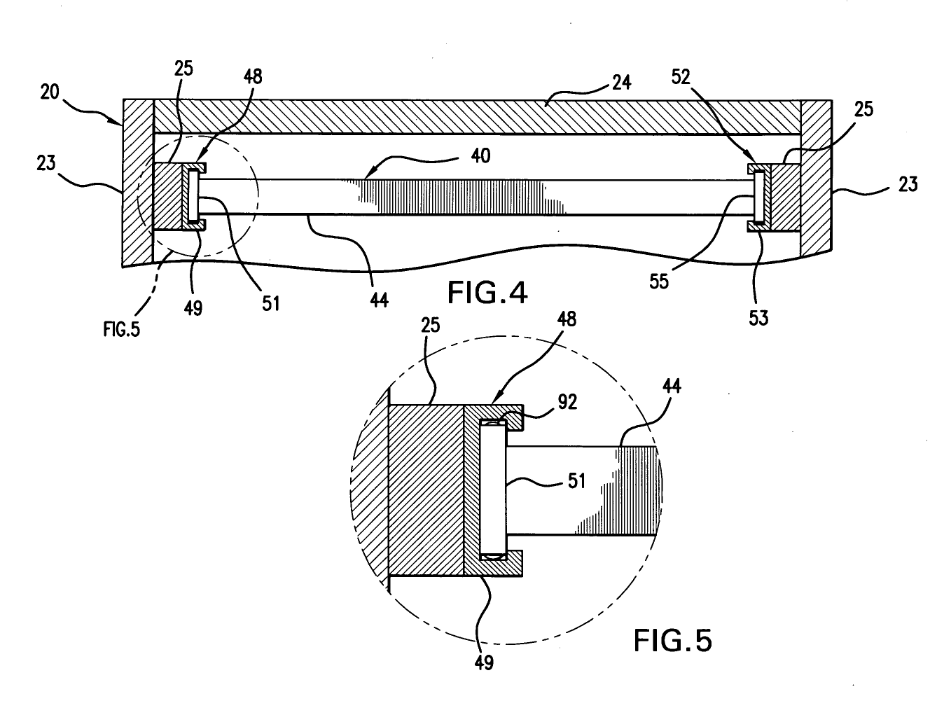

In the most preferred embodiment, and as more fully illustrated in FIGS. 4-6, drawer slides 48, 52 have fixed sections 49, 53 respectively for secure fixed attachment to sides 23 of cabinet 20 and at least one sliding section 51, 55 that is longitudinally extendible from fixed sections 49, 53. Most preferably, drawer slides 48, 52 are full extension slides wherein each has a fixed section such as sections 49, 53, an intermediate sliding section that slides within fixed sections 49, 53, and a third distal section corresponding to sliding sections 51, 55 that slides within the intermediate sliding sections. Such a full extension slide permits the full extension of sliding sections 51, 55 and thus rectilinear brace frame 42 outside of cabinet 20 to facilitate unobstructed access thereto. The movement of sliding sections 51, 55 is further facilitated by the use of ball bearings 92 (FIG. 5), or alternatively rollers, thus minimizing the friction normally encounter between the various sections of drawer slides 48, 52. The construction of full extension drawer slides and three section drawer slides are well known in the industry.

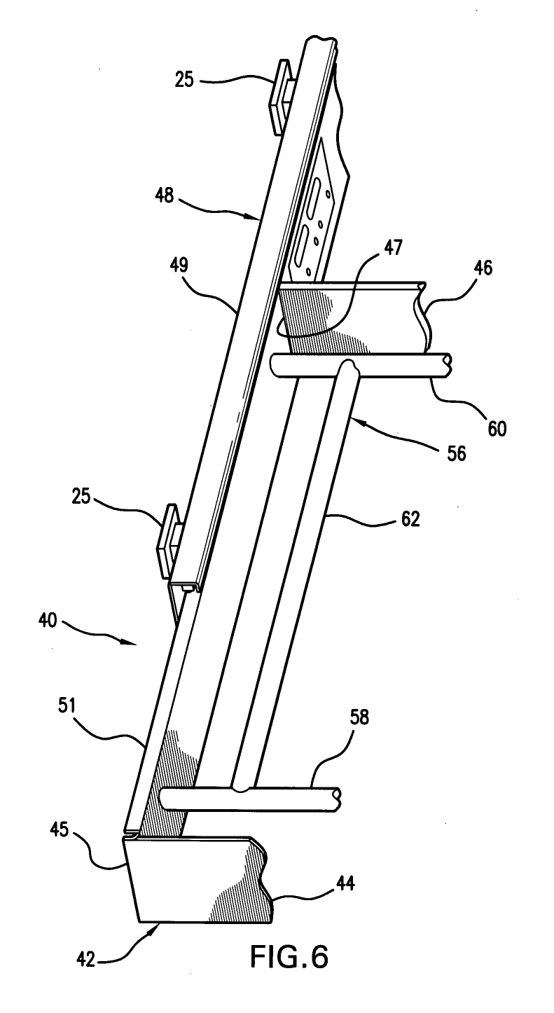

Referring now to FIG. 6, the left side of sliding file support frame 40 is illustrated with the right side being opposite and substantially identical. Rectilinear brace frame 42 as illustrated includes front and rear braces 44, 46 that are vertically oriented flat bars that, as previously described, are longitudinally spaced one from the other by a fixed dimension to accept therebetween file support grid 56. Left ends 45, 47 of braces 44, 46 are affixed to sliding member 51 of drawer slide 48. Braces 44, 46 can be affixed by welding to slide member 51 or can also include portions that form left and right braces (not shown) that are then welded to sliding member 51 or attached to sliding member 51 with mechanical fasteners (not shown).

A file support grid 56 is supported within rectilinear brace frame 42. As further illustrated in FIGS. 2 and 6, file support grid includes front and rear grid rods 58, 60 that are affixed to and transversely extend between sliding sections 51, 55. Grid rods 58, 60 are longitudinally spaced one from the other such that they accept the hooked tabs 27 of hanging folders 28 such that each grid rod 58, 60 supports opposite ends of hanging folders 28 in a longitudinal orientation. File support grid 56 can also include left and right grid rods 62, 64 that extend between and are affixed to front and rear grid rods 58, 60. Left and right grid rods 62, 64 support hooked tabs 27 of hanging folders 29 such that each grid rod 62, 64 supports opposite ends of hanging folders 29 in a transverse orientation. Hanging folders 28, 29 are typically available in multiple standard sizes such as letter size and legal size. File support grid 56 can be constructed such that font and rear grid rods 58, 60 are spaced to accept and support a first of the standard sized hanging folders 28, 29 and such that left and right grid rods 62, 64 support a second of the standard sized hanging folders 28, 29. Left and right grid rods 62, 64 can also be selectively removable to permit the user to selectively configure file support grid 56.

As illustrated in FIG. 1, cabinet 20 includes a front opening door 22. In standard cabinet construction, cabinet 20 also includes vertical stiles 21 on either side of a front opening to cabinet 20 that door 22 is intended to cover. Stiles 21 are non-movably affixed to cabinet 20 therefore requiring the use of spacer mounts 25 between fixed sections 49, 53 of drawer slides 48, 52 and sides 23 of cabinet 20. Spacer mounts 25 properly space drawer slides 48, 52 with respect to stiles 21 to permit rectilinear brace frame 42 to extend through the front opening that is at least partially defined by stiles 21 of cabinet 20.

Referring now to FIG. 3, an alternate embodiment sliding file support frame 140 is illustrated. Like features of sliding file support frame 140 compared to sliding file support frame 40 are identified by the same reference numeral preceded by the numeral “1”. Sliding file support frame 140 is mounted in a double wide cabinet 120 and comprises left and right drawer slides 148, 152 with front and rear braces 158, 160 extending therebetween with a file support grid 156 therein. File support grid 156 includes front and rear grid support rods 158, 160 extending between the left and right sides of rectilinear brace frame 142. First longitudinal grid rod pair 170 extends between front and rear grid rods 158, 160 and is spaced to support transversely oriented hanging folders 29 thereon. Second longitudinal grid rod pair 172 is positioned adjacent to first grid rod pair 170 and also extends between front and rear grid rods 158, 160 to support transversely oriented hanging folders 29.

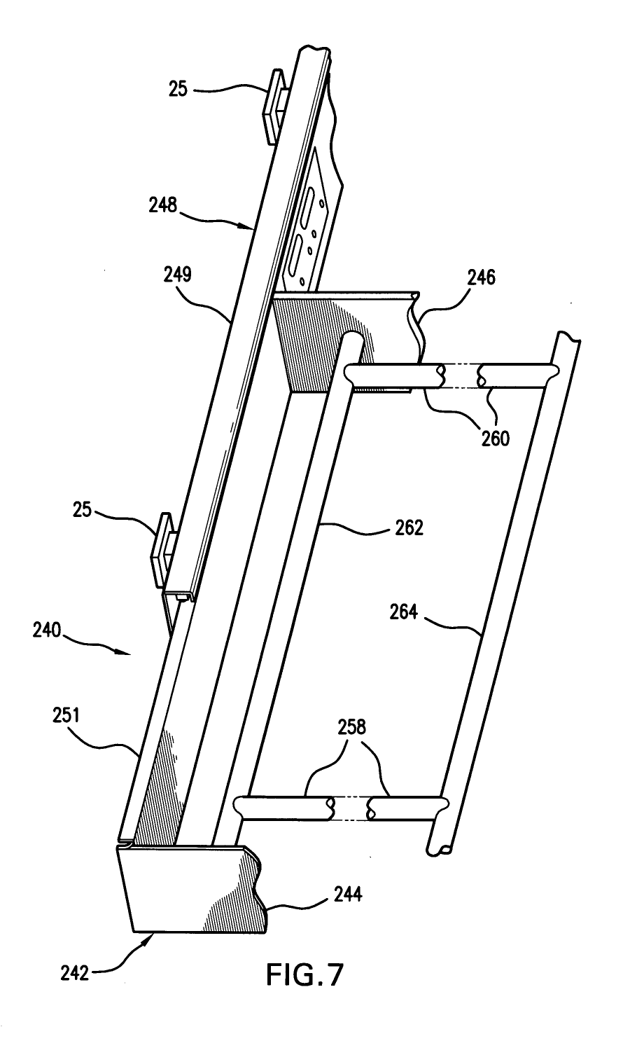

Referring now to FIG. 7, an alternate embodiment sliding file support frame 240 is illustrated. Like features of sliding file support frame 240 compared to sliding file support frame 40 are identified by the same reference numeral preceded by the numeral “2”. Sliding file support frame 240 is substantially identical to file support frame 40 with an alternately configured file support grid 256. File support grid 256 includes left grid rod 262 and a like mounted right grid rod 264 extending longitudinally between and having ends thereof affixed to front and rear braces 244, 246. Left and right grid rods 262, 264 are transversely spaced to support a transversely oriented hanging folder 29. File support grid 256 can also include front and rear grid rods 258, 260 extending between and affixed to left and right grid rods 262, 264. File support grid 256 can be constructed such that left and right grid rods 262, 264 are spaced to accept and support a first of the standard sized hanging folders 28, 29 and such that front and rear grid rods 258, 260 support a second of the standard sized hanging folders 28, 29. Front and rear grid rods 258, 260 can also be selectively removable to permit the user to selectively configure file support grid 256.

Yet another alternate embodiment includes a pair of file support grids 256 mounted side by side in an extended width rectilinear brace frame for mounting in an extended width cabinet such as cabinet 120 (FIG. 3). In this embodiment pairs of longitudinally extending right and left grid rods 262, 264 are mounted in a transversely adjacent manner within the extended width rectilinear brace frame. Each pair of right and left grid rods 262, 264 can also have mounted therebetween a pair of front and rear grid support rods 258, 260.

In use, with sliding file support frame 40 or any of the described alternate embodiments, door 22 of cabinet 20 can be opened and rectilinear brace frame 42 can be longitudinally translated out of cabinet 20 for full access to hanging folders 28, 29. Hanging folders 28, 29 can be upwardly extracted from or inserted into file support grid 56. In the case with a wall mounted cabinet 20 that is raised above the floor, hanging folders 28, 29 can be grasped from the bottom, raised slightly and rotated to extract the desired folder from the bottom of sliding file support frame 40. Reinsertion of hanging folders 28, 29 is accomplished in reverse order of their extraction.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

We/I claim:

1. A sliding file storage frame for mounting in a cabinet of the type having a front opening door, said sliding file storage frame comprising:
a rectilinear brace frame;
a left drawer slide having a fixed section and at least one sliding section affixed to a left side of said rectilinear brace frame;
a right drawer slide having a fixed section and at least one sliding section affixed to a right side of said rectilinear brace frame; and
a hanging file support grid supported intermediate to said front brace and said rear brace and intermediate to said left drawer slide and said right drawer slide.

2. The sliding file storage frame according to claim 1 wherein said left drawer slide and said right drawer slide comprise a fixed section, an intermediate sliding section, and a distal sliding section, said distal sliding section of said left drawer slide affixed to said left side of said rectilinear brace frame and said distal sliding section of said right drawer slide affixed to said right side of said rectilinear brace frame.

3. The sliding file storage frame according to claim 1 wherein said hanging file support grid comprises a front grid rod and a rear grid rod, said front grid rod and said rear grid rod extending between said left side and said right side of said rectilinear brace frame, said front grid rod and said rear grid rod longitudinally spaced one from the other to accept therebetween and support thereon a first size of hanging file.

4. The sliding file storage frame according to claim 3 wherein said hanging file support grid further comprises a left grid rod and a right grid rod, said left grid rod and said right grid rod affixed to and extending between said front grid rod and said rear grid rod, said left grid rod and said right grid rod transversely spaced one from the other to accept therebetween and support thereon a second size of hanging file.

5. The sliding file storage frame according to claim 4 wherein said left grid rod and said right grid rod are selectively removable from said front grid rod and said rear grid rod.

6. The sliding file storage frame according to claim 3 wherein said hanging file support grid further comprises a first longitudinal grid rod pair and an adjacent second longitudinal grid rod pair such that:
said first longitudinal grid rod pair extends between said front grid rod and said rear grid rod and further wherein a left grid rod of said first grid rod pair is transversely spaced from a right grid rod of said first grid rod pair to accept therebetween and support thereon a hanging file, and
said adjacent second longitudinal grid rod pair extends between said front grid rod and said rear grid rod and further wherein a left grid rod of said second grid rod pair is transversely spaced from a right grid rod of said second grid rod pair to accept therebetween and support thereon a hanging file.

7. The sliding file storage frame according to claim 1 wherein said hanging file support grid comprises a left grid rod and a right grid rod, said left grid rod and said right grid rod extending between a front brace of said rectilinear brace frame and a rear brace of said rectilinear brace frame, said left grid rod and said right grid rod spaced one from the other to accept therebetween and support thereon a first size of hanging file.

8. The sliding file storage frame according to claim 7 wherein said hanging file support grid further comprises a front grid rod and a rear grid rod, said front grid rod and said rear grid rod affixed to and extending between said left grid rod and said right grid rod, said front grid rod and said rear grid rod spaced one from the other to accept therebetween and support thereon a second size of hanging file

9. The sliding file storage frame according to claim 8 wherein said front grid rod and said rear grid rod are selectively removable from said left grid rod and said right grid rod.

10. The sliding file storage frame according to claim 1 wherein said hanging file support grid comprises a first longitudinal grid rod pair and an adjacent second longitudinal grid rod pair such that:
said first longitudinal grid rod pair extends between a front brace of said rectilinear brace frame and a rear brace of said rectilinear brace frame and further wherein a left grid rod of said first grid rod pair is transversely spaced from a right grid rod of said first grid rod pair to accept therebetween and support thereon a hanging file, and
said adjacent second longitudinal grid rod pair extends between said front brace of said rectilinear brace frame and said rear brace of said rectilinear brace frame and further wherein a left grid rod of said second grid rod pair is transversely spaced from a right grid rod of said second grid rod pair to accept therebetween and support thereon a hanging file.

11. The sliding file storage frame according to claim 10 wherein said hanging file support grid further comprises a first transverse grid rod pair and an adjacent second transverse grid rod pair such that:
said first transverse grid rod pair extends between said left and right grid rods of said first longitudinal grid rod pair and further wherein a front grid rod of said first transverse grid rod pair is longitudinally spaced from a rear grid rod of said first transverse grid rod pair to accept therebetween and support thereon a hanging file, and
said adjacent second transverse grid rod pair extends between said left and right grid rods of said second longitudinal grid rod pair and further wherein a front grid rod of said second transverse grid rod pair is longitudinally spaced from a rear grid rod of said second transverse grid rod pair to accept therebetween and support thereon a hanging file.

12. A sliding file storage frame for mounting in a cabinet of the type having a front opening door, said sliding file storage frame comprising:
a transversely extending front brace;
a transversely extending rear brace parallel to and longitudinally spaced rearwardly from said front brace;
a left drawer slide having a fixed section and at least one sliding section;
a right drawer slide having a fixed section and at least one sliding section; wherein:
a left end of said front brace and a left end of said rear brace are affixed to said sliding section of said left drawer slide; and
a right end of said front brace and a right end of said rear brace are affixed to said sliding section of said right drawer slide; and
a hanging file support grid supported intermediate to said front brace and said rear brace and intermediate to said left drawer slide and said right drawer slide.

13. The sliding file storage frame according to claim 12 wherein said left drawer slide and said right drawer slide comprise a fixed section, an intermediate sliding section, and a distal sliding section, said distal sliding section of said left drawer slide affixed to said left ends of said front and said rear braces of said rectilinear brace frame and said distal sliding section of said right drawer slide affixed to said right ends of said front and said rear braces of said rectilinear brace frame.

14. The sliding file storage frame according to claim 13 wherein said hanging file support grid comprises a front grid rod and a rear grid rod, said front grid rod and said rear grid rod extending between said distal sliding section of said left drawer slide and said distal sliding section of said right drawer slide, said front grid rod and said rear grid rod longitudinally spaced one from the other to accept therebetween and support thereon a first size of hanging file.

15. The sliding file storage frame according to claim 14 wherein said hanging file support grid further comprises a left grid rod and a right grid rod, said left grid rod and said right grid rod affixed to and extending between said front grid rod and said rear grid rod, said left grid rod and said right grid rod transversely spaced one from the other to accept therebetween and support thereon a second size of hanging file.

16. The sliding file storage frame according to claim 15 wherein said left grid rod and said right grid rod are selectively removable from said front grid rod and said rear grid rod.

17. The sliding file storage frame according to claim 14 wherein said hanging file support grid further comprises a first longitudinal grid rod pair and an adjacent second longitudinal grid rod pair such that:
said first longitudinal grid rod pair extends between said front grid rod and said rear grid rod and further wherein a left grid rod of said first grid rod pair is transversely spaced from a right grid rod of said first grid rod pair to accept therebetween and support thereon a hanging file, and
said adjacent second longitudinal grid rod pair extends between said front grid rod and said rear grid rod and further wherein a left grid rod of said second grid rod pair is transversely spaced from a right grid rod of said second grid rod pair to accept therebetween and support thereon a hanging file.

18. The sliding file storage frame according to claim 13 wherein said hanging file support grid comprises a first longitudinal grid rod pair and an adjacent second longitudinal grid rod pair such that:
said first longitudinal grid rod pair extends between said front brace and said rear brace and further wherein a left grid rod of said first grid rod pair is transversely spaced from a right grid rod of said first grid rod pair to accept therebetween and support thereon a hanging file, and
said adjacent second longitudinal grid rod pair extends between said front brace and said rear brace and further wherein a left grid rod of said second grid rod pair is transversely spaced from a right grid rod of said second grid rod pair to accept therebetween and support thereon a hanging file.

19. The sliding file storage frame according to claim 18 wherein said hanging file support grid further comprises a first transverse grid rod pair and an adjacent second transverse grid rod pair such that:
said first transverse grid rod pair extends between said left and right grid rods of said first longitudinal grid rod pair and further wherein a front grid rod of said first transverse grid rod pair is longitudinally spaced from a rear grid rod of said first transverse grid rod pair to accept therebetween and support thereon a hanging file, and
said adjacent second transverse grid rod pair extends between said left and right grid rods of said second longitudinal grid rod pair and further wherein a front grid rod of said second transverse grid rod pair is longitudinally spaced from a rear grid rod of said second transverse grid rod pair to accept therebetween and support thereon a hanging file.
